(19) United States
(12) Patent Application Publication
(10) Pub. No.: US 2008/0277132 A1
(43) Pub. Date: Nov. 13, 2008

(54) Handheld work apparatus

(76) Inventors: Lubomir Pesik, Liberec (CZ); Johannes Menzel, Wernau (DE); Jurgen Steinmaier, Notzingen (DE); Jurgen Erath, Stuttgart (DE)

Correspondence Address: WALTER OTTESEN, PO BOX 4026, GAITHERSBURG, MD, 20885-4026, US

(21) Appl. No.: 12/149,279

(22) Filed: Apr. 30, 2008

(30) Foreign Application Priority Data
Apr. 30, 2007 (DE) 10 2007 020 368.5

(51) Int. Cl. F02B 63/02

(52) U.S. Cl. 173/213

(57) ABSTRACT

A handheld work apparatus has an internal combustion engine (14, 44, 94) which has a crankshaft (15, 45, 95) which, in turn, drives a work tool of the work apparatus. The work apparatus has a first component group which includes the crankshaft (15, 45, 95) and which is driven in a first rotational direction (10, 40, 70, 90). In order to hold the gyroscopic forces low which act during operation, the work apparatus has a second component group which includes the work tool and which is driven in a second rotational direction (11, 41, 71, 91) opposite to the first rotational direction (10, 40, 70, 90).

### CROSS REFERENCE TO RELATED APPLICATION

This application claims priority of German patent application no. 10 2007 020 368.5, filed Apr. 30, 2007, the entire content of which is incorporated herein by reference.

### FIELD OF THE INVENTION

The invention relates to a handheld work apparatus and especially to a portable handheld work apparatus such as a motor-driven chain saw, cutoff machine, blower apparatus or the like.

### BACKGROUND OF THE INVENTION

German patent publication 2,201,068 discloses a portable motor-driven chain saw wherein the inertial forces of the first order, which develop in the internal combustion engine, are compensated by balancing weights. The balance weights are driven opposite to the crankshaft by a sprocket wheel transmission. However, the total weight of the saw is increased by the additional balance masses and this is disturbing in handheld work apparatus and especially in portable handheld work apparatus.

### SUMMARY OF THE INVENTION

It is an object of the invention to provide a portable handheld work apparatus of the kind described above wherein a good manipulation is permitted which is non-tiring for the operator.

The portable handheld work apparatus of the invention includes: a work tool; an internal combustion engine having a crankshaft for driving the work tool; a first component group including the crankshaft and being driven in a first direction of rotation; and, a second component group including the work tool and being driven in a second direction of rotation opposite to the first direction of rotation.

The inertial forces which are caused by the rotating masses are reduced because the second component group is driven opposite to the first component group. No compensating weights or only lesser additional compensating weights are needed because the work tool is used in order to counter the inertial forces of the internal combustion engine so that the total weight of the work apparatus can be held comparatively low. The counterdriven second component group, which includes the work tool, furthermore leads to a significant reduction of the gyroscopic forces which arise because of the rotating masses. The reduction of the gyroscopic forces simplifies especially for portable handheld work apparatus the manipulation of such uses wherein rapid movements of the work apparatus are needed such as when pivoting a motor-driven chain saw while cutting branches from tree trunks.

The first component group is driven about a first rotational axis and the second component group is driven about a second rotational axis. Advantageously, the first rotational axis and the second rotational axis are at a distance with respect to each other and are approximately parallel to each other. With “approximately parallel” is meant an alignment arranged essentially parallel to each other. Approximately parallel is here seen as an angle between the two rotational axes of up to 10 angular degrees. Preferably, the first and second rotational axes lie within the limits of manufacturing accuracy exactly parallel to each other. It can, however, also be provided that the first rotational axis and the second rotational axis are coincident. With the coincidence of the two rotational axes, an especially good compensation of the inertial forces is possible. Advantageously, the product of the polar mass moment of inertia about the first rotational axis and the rotational speed of the components of the first component assembly is approximately 0.5 time to approximately 2 times the product of the polar mass moment of inertia about the second rotational axis and the rotational speed of the components of the second component assembly. The product of the polar mass moment of inertia and rotational speed yields the angular momentum of the component groups. The product of polar mass moment of inertia about the first rotational axis and the speed of the components of the first component assembly amounts to approximately 0.8 times up to approximately 1.5 times the product of the polar mass moment of inertia about the second rotational axis and the rotational speed of the components of the second component group. It is especially viewed as advantageous when the product of the polar mass moment of inertia and the rotational speed for the two component assemblies are approximately the same.

The first component assembly includes a flywheel. The flywheel is especially configured as a fan wheel for moving cooling air for the internal combustion engine. It can be provided that the work apparatus is a blower apparatus which, as a work apparatus, has a blower wheel for moving work air. The blower apparatus can especially include a blower wheel for moving work air as well as a fan wheel for moving cooling air. The flywheel and the blower wheel are especially driven in mutually opposite directions. It can, however, also be provided that the work apparatus is a cutoff machine which has a cutoff disc as a work tool. Advantageously, the work apparatus is a motor-driven chain saw which has a saw chain as a work tool.

A simple opposite drive of the components of the second component group can be achieved when the work tool is driven by the internal combustion engine via a belt with the belt running crossed over. The crossed over course of the belt makes possible a drive in mutually opposite directions without additional components and therefore without increasing the weight of the work apparatus. It can, however, be provided that the work tool is driven via a gear assembly by the crankshaft. The gear assembly is then especially a sprocket wheel transmission. It can, however, also be provided that the transmission is a planetary transmission. A planetary transmission makes possible the same axis arrangement of drive axis and output axis on the transmission. Different transmission ratios can be achieved with a sprocket wheel transmission as well as with a planetary transmission. Different transmission ratios make possible a good balance of inertial forces for differently large rotating masses. By selecting a suitable transmission ratio, the effective gyroscopic forces can be additionally reduced.

The crankshaft is connected to the work tool via a clutch. The clutch makes possible a simple start of the work apparatus because the work tool is not yet connected to the crankshaft during the start operation. Advantageously, the clutch is driven in a first rotational direction and the first component assembly is formed by crankshaft, flywheel and the clutch. Additional inertial forces such as balancing weights and the like are not provided. In order to further reduce inertial forces during operation, it can, however, also be provided that the clutch is driven in the second rotational direction and that the first component group is formed of the crankshaft and the flywheel. In this way, a good compensation of the inertial forces is made possible in that the work tool as well as the clutch are driven in the direction opposite to the crankshaft and the flywheel. It can, however, also be provided that the flywheel is driven in a direction opposite to the crankshaft in order to reduce gyroscopic forces arising during operation. Especially, the first component assembly includes the work tool and the second component assembly includes a flywheel. The second component assembly is driven in a second rotational direction opposite to the first rotational direction.

### BRIEF DESCRIPTION OF THE DRAWINGS

The invention will now be described with reference to the drawings wherein:

FIG. 1 is a perspective schematic of a cutoff machine having rotational masses;

FIG. 2 is a schematic longitudinal section through a cutoff machine;

FIG. 3 is a schematic cross section through a cutoff machine;

FIGS. 4 and 5 schematically show the drive of the cutoff disc of a cutoff machine;

FIG. 6 is a schematic of a motor-driven chain saw;

FIG. 7 is a schematic of a drive of a motor-driven chain saw;

FIG. 8 is a schematic of an embodiment of the drive of a motor-driven chain saw;

FIG. 9 is a perspective schematic of a blower apparatus; and,

FIG. 10 is a schematic section view of the blower apparatus of FIG. 9.

### DESCRIPTION OF THE PREFERRED EMBODIMENTS OF THE INVENTION

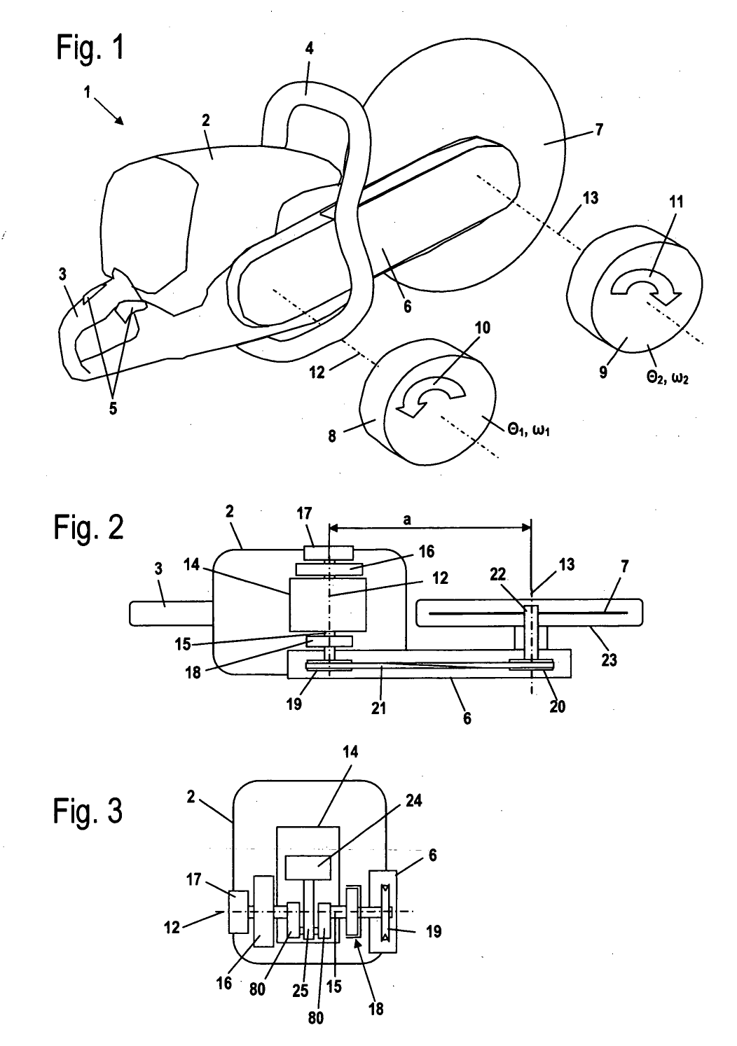

FIG. 1 shows a portable handheld work apparatus in the form of a cutoff machine 1. The cutoff machine 1 has a housing 2 on which a rearward handle 3 and a tubular handle 4 for guiding the cutoff machine 1 are mounted. Operator-controlled elements 5 are attached to the rearward handle 3 and, in the embodiment, include a throttle lever as well as a throttle lever lock. Also, further or other operator-controlled elements can be provided.

An outrigger 6 is mounted on the housing 2 and extends forwardly, that is, on an end of the housing 2 facing away from the rearward handle 3. A cutoff disc 7 is supported on the outrigger 6. The cutoff disc 7 is rotationally driven about a second rotational axis 13.

An internal combustion engine 14 is mounted in the housing 2 of the cutoff machine 1 for driving the cutoff disc 7. The engine is shown schematically in FIGS. 2 and 3. As shown in FIG. 3, the internal combustion engine includes a piston 24 which rotatably drives a crankshaft 15 about a first rotational axis 12 via a connecting rod 25. The first rotational axis 12 is at a distance (a) to the second rotational axis 13 of the cutoff disc 7 as shown in FIG. 2.

As shown in FIGS. 2 and 3, a flywheel 16 is mounted on the crankshaft 15 on the side facing away from the outrigger 6. The flywheel 16 is configured especially as a fan wheel and moves cooling air for the internal combustion engine 14. A starter unit 17 for starting the internal combustion engine is mounted next to the flywheel 16. The internal combustion engine 14 is advantageously configured as a single cylinder engine, especially, as a two-stroke engine or as a mixture lubricated four-stroke engine.

A clutch 18 is provided on the side of the internal combustion engine 14 facing away from the flywheel 16. The clutch connects the crankshaft 15 to the drive disc 19 of a belt drive when a constructively pregiven rotational speed of the crankshaft 15 is exceeded with the connection being such that the drive disc 19 rotates with the crankshaft 15. In addition to the drive disc 19, the belt drive includes an output disc 20 as well as a belt 21 which are shown in FIG. 2. The output disc 20 is rotationally supported on a bearing shaft 22 about the second rotational axis 13. The cutoff disc 7 is also fixedly attached to the bearing shaft 22. As shown in FIG. 2, a protective device 23 is provided on the cutoff disc 7 and partially covers the cutoff disc 7.

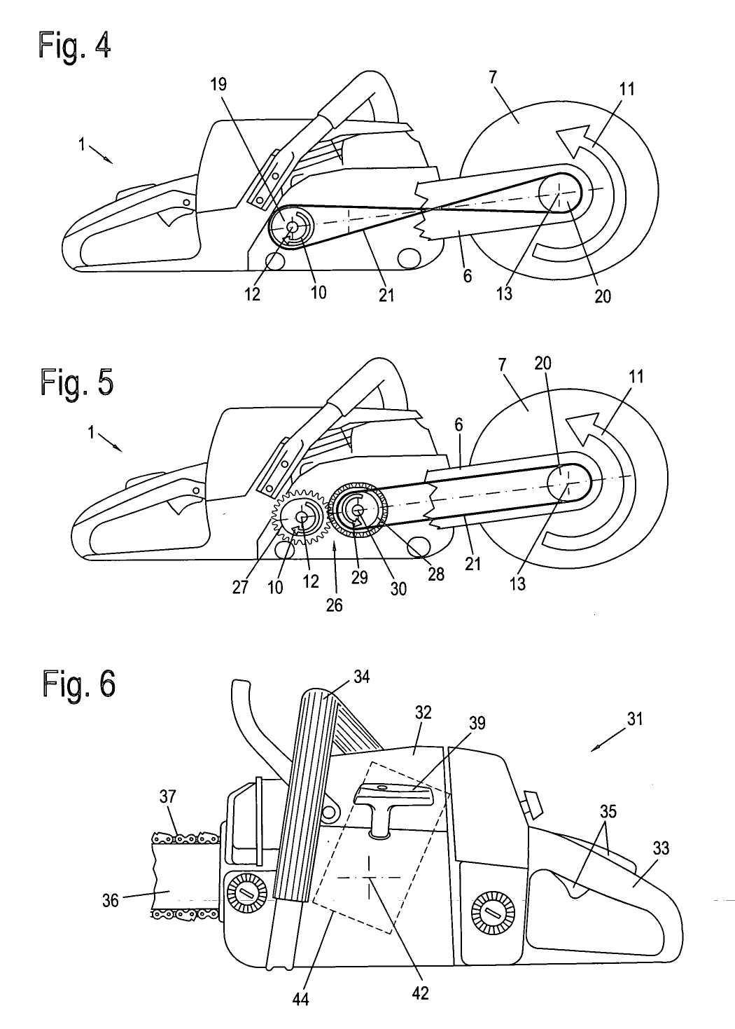

The belt 21 couples the rotational movement of the output disc 20 to the rotational movement of the drive disc 19. The belt 21 is crossed over between the drive disc 19 and the output disc 20 as shown in FIG. 4. In this way, the drive disc 19 is driven in a first rotational direction 10 about the first rotational axis 12 which is opposite in direction to a second rotational direction 11 of the output disc 20 and the cutoff disc 7.

FIG. 1 schematically shows the moments of inertia. For this purpose, a first rotational mass 8 is shown which rotates in the first rotational direction 10 about the first rotational axis 12. The first rotational mass 8 has a polar mass moment of inertia θ₁ and rotates at a rotational speed ω₁. The first rotational mass 8 defines a first component group which is formed by the flywheel 16; the crankshaft 15; the crank webs 80 provided on the crankshaft 15 and shown in FIG. 3; the clutch 18; and, a drive disc 19. The starter device 17 is decoupled from the flywheel 16 during operation and therefore does not contribute to the first rotational mass 8.

In FIG. 1, a second rotational mass 9 is shown which is rotatably driven in a second rotational direction 11 about a second rotational axis 13. The second rotational mass 9 has a polar mass moment of inertia θ₂ and rotates at a rotational speed ω₂. In the embodiment, the drive disc 19 and the output disc 20 are of the same size so that also the rotational speeds ω₁ and ω₂ are equal. However, different rotational speeds ω₁ and ω₂ can be provided. The rotational mass 9 is formed by a second component assembly which includes the output disc 20, the bearing shaft 22 and the cutoff disc 7.

The polar mass moment of inertia is defined as θ=∫r²dm, wherein r is the distance to the rotational axis and m is the mass. A large mass moment of inertia is generated by components having large mass. The mass moment of inertia is determined by the mass distribution and mass elements having a large distance to the rotational axis lead to a large mass moment of inertia. The polar mass moment of inertia θ₁ of the first component group is essentially determined by the flywheel 16, the crankshaft 15 and the clutch 18 and the polar mass moment of inertia θ₂ of the second component assembly is determined essentially by the cutoff disc 7.

To achieve low gyroscopic forces during operation, the product of the polar mass moment of inertia θ and the rotational speed ω for both component assemblies should be as equal as possible. Advantageously, the ratio of the product of the polar mass moment of inertia and the rotational speed of the first component group to the product of the polar mass moment of inertia and rotational speed of the second component group is approximately 0.5 to approximately 2. The ratio amounts especially to approximately 0.8 to approximately 1.5. The polar mass moment of inertia e is determined in each case about the rotational axis about which the components of this component group rotate.

An embodiment for transmitting the rotation of the crankshaft 15 to the cutoff disc 7 is schematically shown in FIG. 5. The crankshaft 15 is connected to the cutoff disc 7 via a spur gear transmission 26. The crankshaft 15 drives a first spur gear 27 about the first rotational axis 12 in a first rotational direction 10. As also shown in FIG. 3 with respect to the first embodiment, the clutch 18 (not shown in FIG. 5) is provided between the crankshaft 15 and the first spur gear 27. The first spur gear 27 rotatingly drives a second spur gear 28 about a rotational axis 30 in a rotational direction 29. The rotational direction 29 is opposite to the first rotational direction 10. The belt 21 is mounted on the second spur gear 28 which drives the output disc 20 in the second rotational direction 11. The second rotational direction 11 corresponds to the rotational direction 29 of the second spur gear 28. The belt 21 of FIG. 5 is not crossed over.

In the embodiment of FIG. 5, the second component assembly rotates about two rotational axes, namely, the rotational axis 30 of the second spur gear 28 and the rotational axis 13 of the cutoff disc 7. When determining the polar mass moment of inertia θ₂ of the second component assembly, the mass moment of inertia of the second spur gear 28 is considered approximately referred to the rotational axis 30 of the second spur gear 28 and is multiplied by the rotational speed of the second spur gear 28. The polar mass moment of inertia θ₂ of the cutoff disc 7 is to be considered as a moment of inertia about the second rotational axis 13 of the cutoff disc 7 and to be multiplied by the rotational speed of the cutoff disc 7. The product of the polar mass moment of inertia and the rotational speed of the components of the second component assembly results in the embodiment of FIG. 5 approximately from the sum of the two individual products. The distance of the rotational axes (13, 30) should be considered additionally for large distances of the rotational axes 13 and 30.

In FIG. 6, a motor-driven chain saw 31 is shown as an embodiment for a portable handheld work apparatus. The motor-driven chain saw 31 has a housing 32 wherein an internal combustion engine 44 is mounted which is shown schematically in FIG. 6. A rearward handle 33 as well as a handle tube 34 are fixed to the housing 32. Two operator-controlled elements 35, namely, a throttle lever as well as a throttle lever lock for operating the motor-driven chain saw 31 are provided on the rearward handle 33. A guide bar 36 is provided on the end of the housing 12 facing away from the rearward handle 33. A saw chain 37 is arranged on the guide bar 36. The internal combustion engine 44 drives the saw chain 37 around the periphery of the guide bar. A pull handle 39 projects from the housing 32 and functions for starting the internal combustion engine 44. In FIG. 6, a first rotational axis 42 is also schematically shown about which the crankshaft of the internal combustion engine 44 is driven.

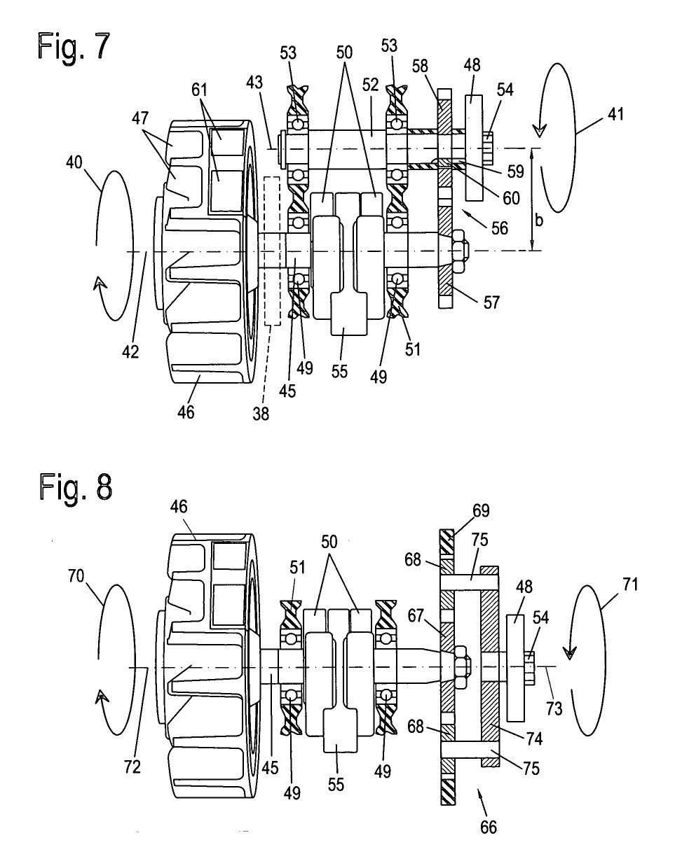

The drive of the motor-driven chain saw 31 is schematically shown in FIG. 7. The internal combustion engine 44 has a crankshaft 45 which is rotatably driven about the rotational axis 42. The internal combustion engine 44 has a crankcase 51 on which the crankshaft 45 is rotatably journalled by bearings 49. A connecting rod 55 is provided on the crankshaft 51 for connecting to a piston (not shown in FIG. 7) of the internal combustion engine 44. The crankshaft 45 has crank webs 50 on both sides of the connecting rod 55 and these crank webs define compensating weights for moving the piston. A flywheel 46 is attached to the crankshaft 45 and has ribs 47 for moving cooling air for the internal combustion engine 44. Pole shoes 61 are furthermore arranged on the periphery of the flywheel 46. The pole shoes 61 are connected to a magnet arranged on the fan wheel 46 and coact with an ignition module (not shown) for controlling the ignition of the internal combustion engine. The crankshaft 45 rotates together with the flywheel 46 about the first rotational axis 42 in a first rotational direction 40.

A spur wheel transmission 56 is provided on the side of the crankcase 51 lying opposite the flywheel 46. A first spur gear 57 of the spur gear transmission 56 is connected to the crankshaft 45 so as to rotate therewith. The first spur gear 57 drives a second spur gear 58 about a second rotational axis 43 in a second, opposite, rotational direction 41. The second spur gear 58 is connected to a bearing shaft 52 so as to rotate therewith. For this purpose, a slot 59 is provided wherein a spline or key 60 is mounted. The bearing shaft 52 is journalled in the crankcase 51 via bearings 53. It can, however, be provided that the bearing shaft 52 is journalled in another component, for example, in the housing 32. The crankcase 51 can also be integrated into housing 32.

On the bearing shaft 52, a clutch 48 is mounted to provide a connection of the bearing shaft 52 with a drive sprocket 54 which connects the bearing shaft 52 to the drive sprocket 54 so as to cause the drive sprocket to rotate therewith when a constructively pregiven rotational speed is exceeded. The drive sprocket 54 drives the saw chain 37.

The bearing shaft 52, the second spur gear 58, the clutch 48 and the drive sprocket 54 as well as the saw chain 37 are driven about the second rotational axis 43 in the second rotational direction 41. Since the saw chain 37 does not carry out a rotational movement but a movement about the guide bar 36, a rotation about the second rotational axis 43 can be assumed by approximation. More precise values result when the geometric center line of the running saw chain is determined as rotational axis. This center line runs perpendicularly to the plane of the guide bar 36 and intersects the guide bar 36 at a center region.

The motor-driven chain saw 31 has a first component assembly made up of crankshaft 45, flywheel 46 and a first spur gear 57 which are driven about the rotational axis 42 in a first rotational direction 40 as well as a second component assembly which is formed by the second spur gear 58, the bearing shaft 52, the clutch 48, the drive sprocket 54 and the saw chain 37 and which is driven about the second rotational axis 43 in a second, opposite, rotational direction 41. The two rotational axes 42 and 43 are at a distance (b) from each other. The two rotational axes 42 and 43 lie parallel to each other. The axis offset between the two rotational axes 42 and 43 results from the use of a one-stage spur gear transmission 56.

In another embodiment of the motor-driven chain saw 31, a transmission 38 can be provided between the flywheel 46 and the crankshaft 45 and shown in phantom outline in FIG. 7. This causes the condition that the flywheel 46 rotates in the rotational direction 41 shown in FIG. 7 in the direction opposite to the crankshaft 45. It can be advantageous that in lieu thereof, the transmission 56 is omitted so that a first component group includes the crankshaft 45, the clutch 48, the drive sprocket 54 and the saw chain 37 and a second component assembly, which rotates in the opposite direction, is formed by the flywheel 46. The first component group rotates in rotational direction 40 and the second component group rotates in the rotational direction 41. It can also be provided that the transmission 38 as well as the transmission 56 are provided so that flywheel 46, clutch 48, drive sprocket 54, bearing shaft 42 and the saw chain 37 are driven in the rotational direction 41 opposite to the crankshaft 45. The transmission 38 can be either a planetary transmission or a spur gear transmission. Also, another embodiment of the transmission 38 can be advantageous.

As shown in FIG. 8, the axis offset can be avoided by using a planetary transmission 66. The drive of FIG. 8 corresponds essentially to the drive of FIG. 7. The same reference characters are used for the same components.

The first component group made up of flywheel 46, crankshaft 45 as well as a sun gear 67 of the planetary transmission 66 is rotatably driven about a first rotational axis 72 in a first rotational direction 70. The sun gear 67 drives several planetary gears 68 which rotate between the sun gear 67 and an annular gear 69 fixed in location. The annular gear 69 can, for example, be connected to the housing 32 or to the crankcase 51. The planetary gears 68 have bearing pins 75 which are held in a planetary carrier 74. The planetary gears 68 drive the planetary carrier 74 about a second rotational axis 73 in a second opposite rotational direction 71. The first rotational axis 72 and the second rotational axis 73 are coincident. The planetary carrier 74 is connected to the clutch 48 which, in turn, is connected to the drive sprocket 54. In the embodiment of FIG. 8, the second component group is driven oppositely in the second rotational direction 71 and is formed by the planetary gears 68, the bearing pins 75, the planetary carrier 74, the clutch 48, the drive sprocket 54 and the peripherally-driven saw chain 37.

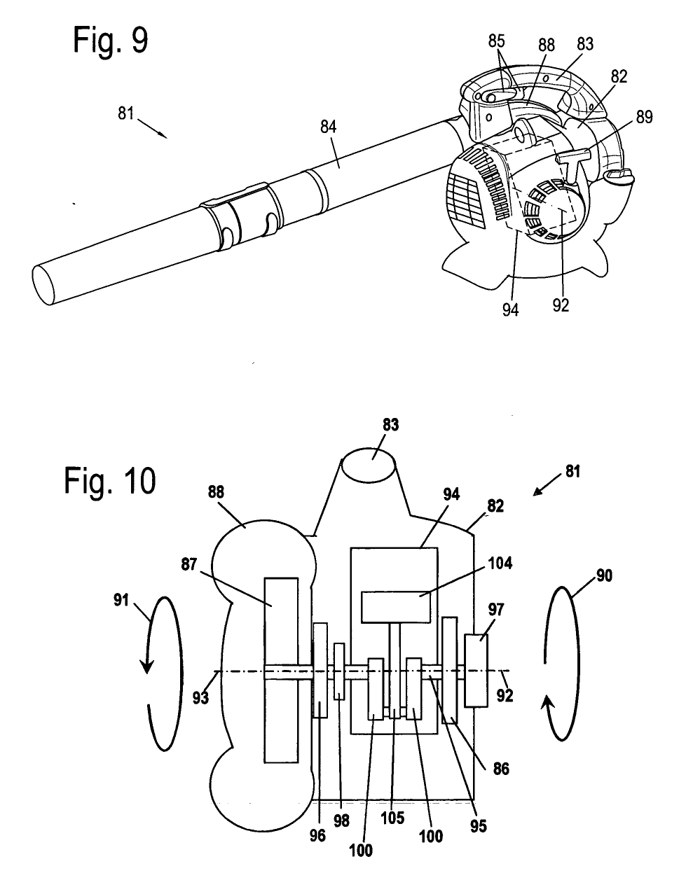

In FIGS. 9 and 10, a blower 81 is shown as a further embodiment of a portable handheld work apparatus. The blower apparatus 81 has a housing 82 and a handle 83 is fixed to the upper side of the housing 82. On the housing 82, a blower tube 84 is mounted through which an internal combustion engine 94 mounted in the housing 82 moves an air flow as work air. Operator-controlled elements for operating the blower apparatus 81 are mounted on the handle 83 and next to the handle 83. A pull rope handle 89 projects from the housing 82 and functions for actuating a starter device of the internal combustion engine 94.

The blower apparatus 81 is schematically shown in FIG. 10. The internal combustion engine 94 is mounted in the housing 82 of the blower apparatus 81 and has a piston 104. The piston 104 rotatably drives a crankshaft 95 about a first rotational axis 92 via a connecting rod 105. The first rotational axis 92 is also shown in FIG. 9. The crankshaft 95 is driven in a first rotational direction 90. Crank webs 100 are mounted on both sides of the connecting rod 105 in order to balance the inertial forces caused by the piston 104. A flywheel 86 is fixed on the crankshaft 95 and moves cooling air for the internal combustion engine 94. A starter unit 97 is provided on the side of the flywheel 86 facing away from the internal combustion engine 94. The starter unit 97 is actuated via the pull rope handle 89 shown in FIG. 9.

A clutch 98 is connected to the crankshaft 95 on the opposite-lying side of the internal combustion engine 94. The crankshaft 95 can be connected to a planetary transmission 96 shown schematically in FIG. 10 via the clutch 98 so as to rotate with the crankshaft as soon as the crankshaft 95 exceeds a constructively predetermined rotational speed. The configuration of the planetary transmission 96 corresponds to the planetary transmission 66 shown in FIG. 8. The planetary transmission 96 rotatingly drives a blower wheel 87 about a second rotational axis 93. The blower wheel 87 is driven in a second rotational direction 91 which runs opposite to the first rotational direction 90. The blower apparatus 81 has the blower spiral 88 through which the blower wheel 87 moves the work air flow of the blower apparatus into the blower tube 84. As shown in FIG. 10, the first rotational axis 92 and the second rotational axis 93 are coincident. In the blower apparatus 81 of FIGS. 9 and 10, a spur gear transmission can be used in lieu of the planetary transmission 96. Also, another type of transmission can be provided.

An opposite drive of a component group, which also includes the single work tool of the work apparatus, can also be advantageous in other work apparatus and especially portable handheld work apparatus.

For all work apparatus, the product of the polar mass moment of inertia about the first rotational axis and the angular velocity or rotational speed of the components of the first component group should amount approximately to 0.5 times up to approximately 2 times the product of the polar mass moment of inertia about the second rotational axis and the rotational speed of the components of the second component group. Advantageously, the product of the polar mass moment of inertia about the first rotational axis and of the rotational speed of the components of the first component group amounts to approximately 0.8 times to 1.5 times the product of the polar mass moment of inertia about the second rotational axis and the rotational speed of the components of the second component group. If a component group has several rotational axes or several rotational speeds, then the approximate sum of the particular product of mass moment of inertia and rotational speed can be formed for each case. For large distances of the rotational axes, especially, when the rotational axes do not lie in a plane, the distance of the rotational axes is to be considered according to the rule of Steiner. Advantageously, the products of the polar mass moment of inertia and the rotational speed for the two component groups are of the same magnitude. It can be provided in addition or alternatively that the flywheel is driven in a direction opposite to the crankshaft.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a work tool;
an internal combustion engine having a crankshaft for driving said work tool;
a first component group including said crankshaft and being driven in a first direction of rotation; and,
a second component group including said work tool and being driven in a second direction of rotation opposite to said first direction of rotation.

2. The handheld work apparatus of claim 1, wherein said first component group is driven about a first rotational axis and said second component group is driven about a second rotational axis.

3. The handheld work apparatus of claim 2, wherein said first and second rotational axes are mutually parallel and are spaced at a predetermined distance from each other.

4. The handheld work apparatus of claim 2, wherein said first and second rotational axes are coincident.

5. The handheld work apparatus of claim 2, wherein said first component group defines a first polar mass moment of inertia (θ₁) rotating about said first rotational axis and has first components rotating about said first rotational axis at a first angular velocity (ω₁); said second component group defines a second polar mass moment of inertia (θ₂) rotating about said second rotational axis and has second components rotating about said second rotational axis at a second angular velocity (ω₂); and, the product of said first mass moment of inertia (θ₁) and said first angular velocity (ω₁) is approximately 0.5 times to approximately 2 times the product of said second mass moment of inertia (θ₂) and said second angular velocity (ω₂).

6. The handheld work apparatus of claim 5, wherein said product of said first mass moment of inertia (θ₁) and said first angular velocity (ω₁) is approximately 0.8 times to approximately 1.5 times the product of said second mass moment of inertia (θ₂) and said second angular velocity (ω₂).

7. The handheld work apparatus of claim 1, wherein said first component group includes a flywheel.

8. The handheld work apparatus of claim 7, wherein said flywheel is configured as a fan wheel for moving cooling air for said internal combustion engine.

9. The handheld work apparatus of claim 1, wherein said work apparatus is a blower apparatus and said work tool is a blower wheel for moving work air.

10. The handheld work apparatus of claim 1, wherein said work apparatus is a cutoff machine and said work tool is a cutoff disc.

11. The handheld work apparatus of claim 1, wherein said work apparatus is a motor-driven chain saw and said work tool is a saw chain.

12. The handheld work apparatus of claim 1, further comprising a belt operatively connecting said internal combustion engine to said work tool for permitting said internal combustion engine to drive said work tool; and, said belt being crossed over between said internal combustion engine and said work tool

13. The handheld work apparatus of claim 1, further comprising a transmission operatively connecting said crankshaft to said work tool so as to permit said crankshaft to drive said work tool via said transmission.

14. The handheld work apparatus of claim 13, wherein said transmission is a spur gear transmission.

15. The handheld work apparatus of claim 13, wherein said transmission is a planetary transmission.

16. The handheld work apparatus of claim 1, further comprising a clutch operatively connecting said crankshaft to said work tool so as to permit said crankshaft to drive said work tool via said clutch.

17. The handheld work apparatus of claim 16, wherein said clutch is driven in said first direction of rotation and said first component group comprises said clutch, said crankshaft and a flywheel.

18. The handheld work apparatus of claim 16, wherein said clutch is driven in said second direction of rotation and said first component group comprises said crankshaft and said flywheel.

19. A handheld work apparatus comprising:
a work tool;
an internal combustion engine having a crankshaft for driving said work tool;
a first component group including said crankshaft and being driven in a first direction of rotation; and,
a second component group including a flywheel and being driven in a second direction of rotation opposite to said first direction of rotation.
